(19) United States
(12) Patent Application Publication
(10) Pub. No.: US 2024/0266956 A1
(43) Pub. Date: Aug. 8, 2024

(54) ZERO VOLTAGE SWITCHING IN A BUCK CONVERTER

(71) Applicant: POWER INTEGRATIONS, Inc., SAN JOSE, CA (US)

(72) Inventors: NOAM EZRA, CAMBRIDGE (GB); ANTONIUS JACOBUS JOHANNES WERNER, CAMBRIDGE (GB); DAVID MICHAEL HUGH MATTHEWS, LOS GATOS, CA (US)

(73) Assignee: POWER INTEGRATIONS, Inc., SAN JOSE, CA (US)

(21) Appl. No.: 18/290,144

(22) PCT Filed: Jun. 7, 2022
(86) PCT No.: PCT/US2022/032453

§ 371 Date: Nov. 9, 2023

Related U.S. Application Data
(60) Provisional application No. 63/212,470, filed on Jun. 18, 2021.

(51) Int. Cl. H02M 3/158; H02M 1/00

(52) U.S. Cl. CPC H02M 3/158; H02M 1/0058

(57) ABSTRACT

Zero voltage switching in a BUCK converter is disclosed herein. A current reversing path is electrically coupled in parallel with a freewheeling diode. The current reversing path may be configured to reverse energize the inductor during a subinterval of the switching cycle.

### CROSS-REFERENCE TO RELATED APPLICATIONS

This application claims the benefit of U.S. Provisional Application No. 63/212,470 filed on Jun. 18, 2021, incorporated in its entirety herein by reference.

### FIELD OF THE DISCLOSURE

The present invention relates to zero voltage switching in a BUCK converter and more particularly to zero voltage switching in a BUCK converter using a freewheeling diode.

### BACKGROUND INFORMATION

Many electronic devices, such as cell phones, laptops, etc., are powered by direct current (dc) power derived from a power supply. Conventional wall outlets generally deliver a high voltage alternating current (ac) power that needs to be converted to regulated dc power in order to be used as a power source for consumer electronic devices. Switch mode power converters, also referred to as switch mode power supplies (SMPSs), are commonly used due to their high efficiency, small size, and low weight to convert a high voltage ac power (or high voltage input dc power) to a regulated output dc power.

Many electronic devices have multiple loads and require more than one dc power source in order to operate. For instance, an audio electronic device may have system components which operate at five volts and audio components which operate at twelve volts. In these applications a multi-output power converter converts input power to multiple dc power outputs to provide regulated dc power to each of the multiple loads.

In one application a BUCK converter, also known as a step-down converter, may be used to convert input power at a high voltage, say greater than one-hundred volts, down to a lower voltage. In these applications the BUCK converter may operate in one of several modes: continuous conduction mode (CCM), boundary conduction mode (BCM), and/or discontinuous conduction mode (DCM).

### BRIEF DESCRIPTION OF THE DRAWINGS

Non-limiting and non-exhaustive embodiments of zero voltage switching in a BUCK converter are described with reference to the following figures, wherein like reference numerals refer to like parts throughout the various views unless otherwise specified.

FIG. 1A illustrates a power converter system including a BUCK converter according to an embodiment.

FIG. 1B illustrates a BUCK converter including a current reversing path according to an embodiment.

FIG. 1C illustrates a BUCK converter including a current reversing path according to another embodiment.

FIG. 2 illustrates waveforms during a switching cycle according to the teachings herein.

FIG. 3A illustrates an inductor current path during a subinterval of a switching cycle according to an embodiment.

FIG. 3B illustrates an inductor current path during a subinterval of the switching cycle according to an embodiment.

FIG. 3C illustrates an inductor current path during a subinterval of the switching cycle according to an embodiment.

FIG. 3D illustrates an inductor current path during a subinterval of the switching cycle according to an embodiment.

FIG. 3E illustrates an inductor current path during a subinterval of the switching cycle according to an embodiment.

FIG. 4 illustrates a conceptual flow diagram of zero voltage switching during a switching cycle according to an embodiment.

FIG. 5 compares waveforms during a switching cycle according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the teachings herein. Also, common but well-understood elements that are useful or necessary in a commercially feasible embodiment are often not depicted in order to facilitate a less obstructed view of these various embodiments of zero voltage switching in a BUCK converter.

### DETAILED DESCRIPTION

In the following description, numerous specific details are set forth in order to provide a thorough understanding of zero voltage switching in a BUCK converter. It will be apparent, however, to one having ordinary skill in the art that the specific detail need not be employed to practice the teachings herein. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of zero voltage switching in a BUCK converter. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, microcontrollers, digital signal processors, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

In the context of the present application, when a transistor is in an “off-state” or “off” the transistor blocks current and/or does not substantially conduct current. Conversely, when a transistor is in an “on-state” or “on” the transistor is able to substantially conduct current. By way of example, in one embodiment, a high-voltage transistor comprises an N-channel metal-oxide-semiconductor (NMOS) field-effect transistor (FET) with the high-voltage being supported between the first terminal, a drain, and the second terminal, a source. In some embodiments an integrated controller circuit may be used to drive a power switch when regulating energy provided to a load. Furthermore, as one of ordinary skill in the art may appreciate a FET may be realized as a metal oxide field effect transistor (MOSFET).

Also, for purposes of this disclosure, “ground” or “ground potential” refers to a reference voltage or potential against which all other voltages or potentials of an electronic circuit or Integrated circuit (IC) are defined or measured.

As mentioned above, a BUCK converter, also referred to as a step-down converter, is a switched mode power converter for converting input power at a high voltage to output power at a low voltage. In the steady state the BUCK converter may convert input voltage to output voltage according to a function of duty cycle D. For instance, in continuous conduction mode (CCM) a BUCK converter may provide an output voltage in proportion to the duty cycle D times the input voltage.

In power (e.g., high voltage) applications where the input voltage to output voltage necessitates a small duty cycle; a practical realization of a BUCK converter becomes problematic.

For instance, using a BUCK topology (i.e., BUCK converter) for universal mains applications at high input voltages (e.g., 90 to 265 volts ac (Vac)) or even higher voltages may increase switching loss. As input voltages increase above 90 Vac, switching losses can become a significant component of loss; and switching losses may exceed switch conduction losses.

Switching losses, including turn-on losses, may be determined, at least in part, by switch node capacitance. Unfortunately, while switch node capacitance may be slightly improved by choosing a switch (e.g., a gallium nitride field effect transistor) with lesser output capacitance Coss, switch node capacitance cannot be eliminated. For instance, other components of parasitic capacitance, such as diode capacitance (e.g., a freewheeling diode capacitance) remain. Accordingly, there is a need for alternatives to reducing turn-on losses in BUCK converters and in power applications necessitating small duty cycle.

Zero voltage switching in a BUCK converter is disclosed herein. A current reversing path is electrically coupled in parallel with a freewheeling diode. The current reversing path may be configured to reverse energize the inductor during a subinterval of the switching cycle. In this regard, a subinterval may also be a portion of time; and a subinterval of a switching cycle may be referred to as a portion of the switching cycle.

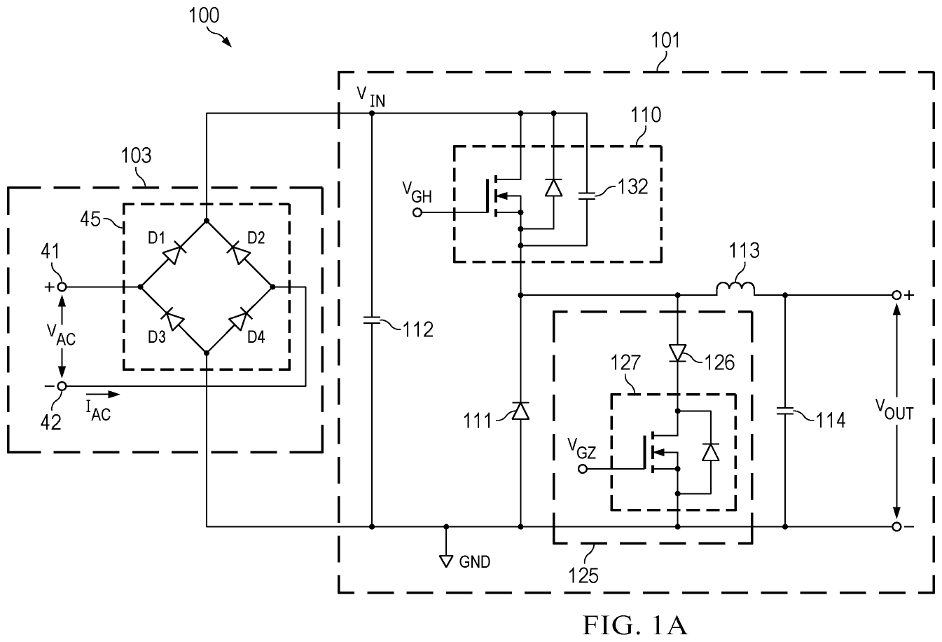

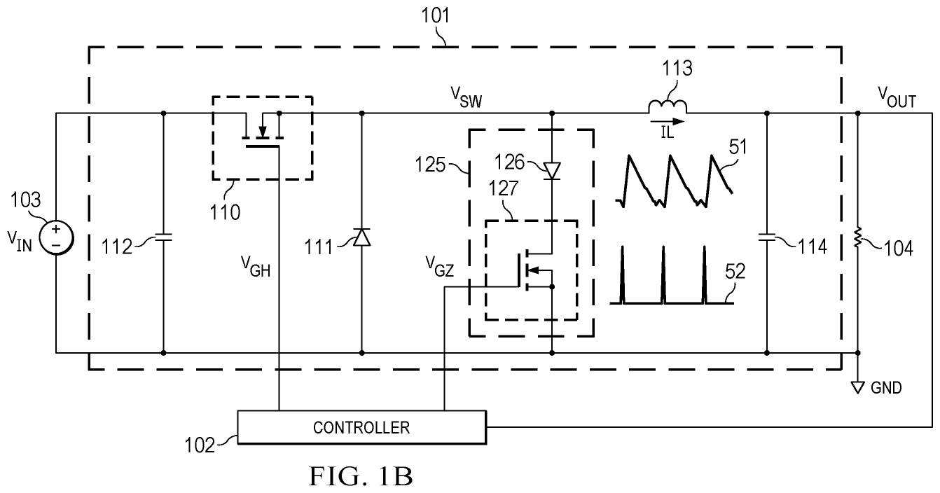

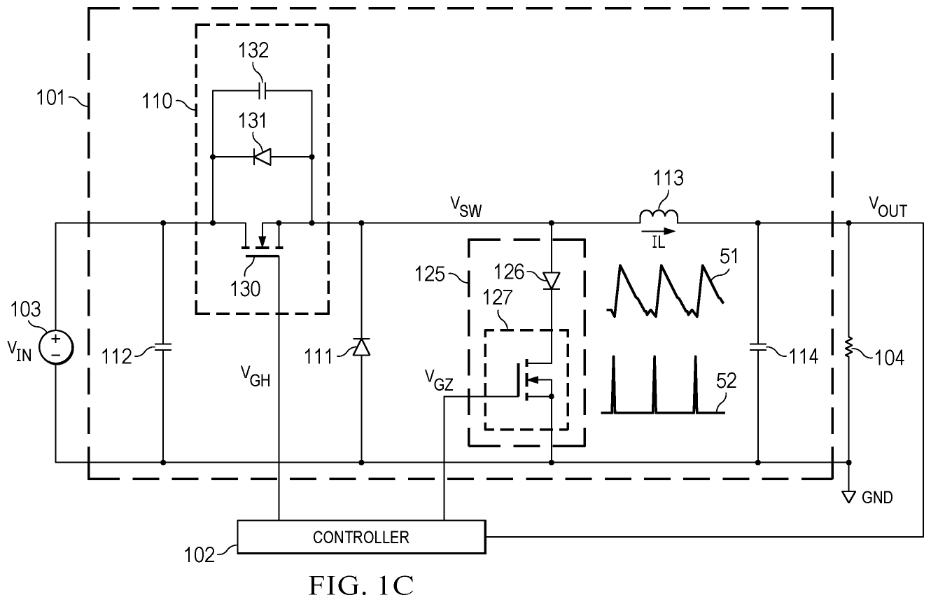

FIG. 1A illustrates a power converter system 100 including a BUCK converter 101 according to an embodiment. The power converter system 100 includes a power source 103 and a BUCK converter 101. According to switch mode power converter theory, the BUCK converter 101 may down convert a de input voltage (i.e., input voltage V_{IN}) to a lower dc output voltage (i.e., output voltage V_{OUT}). According to the teachings herein, the BUCK converter 101 includes a current reversing path 125, which may avail zero voltage switching (ZVS) to enhance converter efficiency.

The power source 103 includes a bridge rectifier 45 which converts alternating current (ac) power (i.e., ac voltage V_{AC} and ac current I_{AC}) into the input voltage V_{IN}. The bridge rectifier includes diodes D1-D4 which may rectify the ac voltage V_{AC} between input terminal 41 and input terminal 42. In turn, the bridge rectifier 45 may provide the input voltage V_{IN} as a rectified dc input voltage V_{IN}.

In one application the ac voltage V_{AC} may be a universal mains application with an ac voltage V_{AC} between ninety and two-hundred sixty-five ac volts (90-265 Vac) or even higher. Although the power converter system 100 shows the input voltage V_{IN} as being derived from ac power (i.e., ac voltage V_{AC} and ac current I_{AC}), other applications are possible. For instance, the input voltage V_{IN} may be derived from a dc power supply.

As illustrated in FIGS. 1A and 1n FIG. 1B, the BUCK converter 101 includes a high side switch 110, an input capacitor 112, a freewheeling diode 111, a current reversing path 125, an inductor 113, and an output capacitor 114.

The high side switch 110 includes a capacitor 132 which may comprise and/or represent a lumped (e.g., total parasitic) capacitance. For instance, capacitor 132 may comprise an output capacitance Coss; which according to semiconductor device theory, may include a drain to source capacitance Cds and a gate to drain capacitance Cgd. As described above, a power FET output capacitance Coss may degrade efficiency due to turn on losses (i.e., switching losses).

As described below with respect to FIG. 1B, a controller 102 may provide control signals (e.g., gate signals V_{GH} and V_{GZ}) to the high side switch 110 and to the current reversing path 125. According to the teachings herein, gate signals V_{GH} and V_{GZ} may be provided to avail zero voltage (ZVS) switching. The method of ZVS switching described herein may provide a way to advantageously reduce turn on losses, improve efficiency, and/or increase switching frequency.

The current reversing path 125 includes a diode 126 electrically coupled to an N-channel field effect transistor (NFET) 127. The NFET 127 may also be referred to as a zero voltage switching (ZVS) metal oxide field effect transistor (MOSFET). The NFET 127 may be an additional high-voltage (HV) MOSFET to allow the high side switch 110 to undergo zero voltage switching. Moreover, because reverse current in the inductor 113 may be relatively low compared to that of a main buck inductor current, NFET 127 may advantageously be smaller (i.e., occupy less area) than the high side switch 110.

FIG. 1B illustrates BUCK converter 101 including a current reversing path 125 according to an embodiment. The BUCK converter 101 may receive input power (i.e., input voltage V_{IN}) from a power source 103 and provide output power (i.e., output voltage V_{OUT}) to a load 104. A controller 102 receives the output voltage V_{OUT} and controls switching of the BUCK converter 100 so that the output voltage V_{OUT} may be regulated.

As discussed above, the BUCK converter 101 includes a high side switch 110, an input capacitor 112, a freewheeling diode 111, a current reversing path 125, an inductor 113, and an output capacitor 114. Although the high side switch 110 is illustrated as an N-channel field effect transistor (NFET) 110; other configurations are possible. For instance, a P-channel field effect transistor may also be used as a high side switch 110.

Also as illustrated, the current reversing path 125 includes a diode 126 electrically coupled in series with an N-channel field effect transistor (NFET) 127. Additionally, the high side switch 110 is electrically coupled with the freewheeling diode 111 to provide switch node voltage V_{SW}. Also, as shown, the inductor 113 is electrically coupled between the high side switch 110 and the output capacitor 114; and the current reversing path 125 is electrically coupled in parallel with the freewheeling diode 111.

According to switch mode power converter theory, the controller 102 may control the high side switch 110 to turn on and to turn off in response to a gate signal V_{GH} and according to a switching cycle. As discussed above, a duty cycle D may depend, at least in part, upon the relationship between the input voltage V_{IN} and the output voltage V_{OUT}; and in power applications, switching losses related to switching the high side switch 110 may become dominant as duty cycle D decreases.

For instance, waveform 51 depicts inductor current IL for low duty cycle D when the BUCK converter 101 operates in discontinuous conduction mode (DCM). According to the teachings herein, the current reversing path 125 may be used to sink current (i.e., receive current) from the inductor 113. In this manner the inductor 113 may become reverse energized and allow zero voltage switching (ZVS).

Additionally, by virtue of the series connection of diode 126 and NFET 127, the current reversing path 125 may operate as a single quadrant switch. Thus, current conducts (flows) in a single direction (i.e., current sinking). When the NFET 127 comprises a body diode, then series coupling further prevents reverse current from flowing through the body diode of NFET 127.

Additionally, the controller 102 may provide a pulsed gate signal V_{GZ} to the NFET 127 during the switching cycle to reverse energize the inductor 113. For instance, waveform 52 depicts gate signal V_{GZ} while the BUCK converter 101 operates in DCM.

Having the current reversing path 125 electrically coupled in parallel with the freewheeling diode 111 may advantageously reduce cost and enhance performance. For instance, the current reversing path 125 may be designed to sink less current relative to that of the freewheeling diode 111. Thus, the NFET 127 may be selected to have smaller area relative to that of the high side switch 110 and to that of the freewheeling diode 111.

Although the embodiment of FIG. 1B shows the current reversing path 125 as comprising a diode 126 electrically coupled in series to the drain of NFET 127; other configurations are possible. For instance, a current reversing path 125 may also be realized with a bipolar junction transistor (BJT) (i.e., an NPN BJT) to operate as a single quadrant switch. Alternatively, and additionally, a current reversing path 125 may use a gallium nitride GaN transistor (e.g., a GaN FET) and/or a GaN cascode switch. For instance, the current reversing path 125 may comprise a fast recovery GaN cascode switch. As one of ordinary skill in the art may appreciate, a GaN cascode switch may comprise a depletion mode GaN FET connected in cascode with an enhancement mode FET (e.g., an enhancement mode NFET).

FIG. 1C illustrates the BUCK converter 101 including the current reversing path 125 according to another embodiment. The embodiment of FIG. 1C is like that of FIG. 1B, except the high side switch 110 is modelled as an NFET 130 having a body diode 131 and capacitor 132 electrically coupled in parallel across the source and drain of NFET 130. Diode 126 may advantageously mitigate reverse conduction in NFET 127. For instance, when NFET 127 comprises a body diode or fast internal diode, then diode 126 assures that the current reversing path 125 operates as a single quadrant switch. Alternatively, and additionally, when NFET 127 comprises a body diode, which can sustain reverse conduction (i.e., can sustain body diode current), then diode 126 may be excluded and/or optional.

As illustrated, the source of the NFET 130 (high side switch 110) is electrically coupled to the cathode of the freewheeling diode 111 and to the inductor 113.

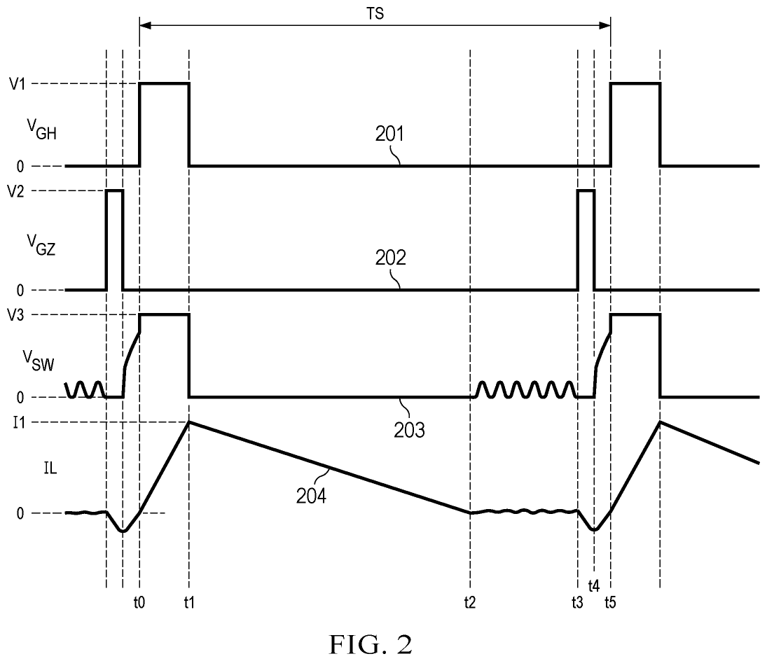

FIG. 2 illustrates waveforms 201-204 during a switching cycle of duration TS according to the teachings herein. Waveforms 201-204 may correspond with gate signal V_{GH}, gate signal V_{GZ}, switch node voltage V_{SW}, and inductor current IL, respectively.

The switching cycle begins at time to when the gate signal V_{GH} is exerted high. In turn the high side switch turns on so that the inductor 113 is energized with increasing (ramping) inductor current IL. During a subinterval (i.e., a subinterval of the switching cycle) from time t0 to time t1, the gate signal V_{GH} is exerted high with value V1; and the high side switch 110 is turned on to provide switch node voltage V_{SW} and energize inductor 113. While inductor 113 is energized, the inductor current IL increases from 0 to a peak value Il and the switch node voltage V_{SW} may be approximately equal to V3. In one embodiment V3 may be substantially equal to the input voltage V_{IN}.

At time t1 the gate signal V_{GH} is switched low. During a subinterval from time t1 to time t2, the inductor 113 is de-energized while inductor current IL is provided via the freewheeling diode 111. As illustrated, during the subinterval from time t1 to time t2 the freewheeling diode 111 is forward biased so that the switch node voltage V_{SW} may be slightly less than and/or substantially equal to zero.

At time t2 the inductor 113 may be substantially de-energized so that the freewheeling diode 111 becomes reverse biased while the high side switch 110 is turned off. In this manner the switch mode converter 101 enters discontinuous conduction mode (DCM) with the switch node voltage V_{SW} undergoing oscillations (ringing) during a subinterval from time t2 to time t3.

At time t3 gate signal V_{GZ} is exerted high (i.e., transitions to value V2) and the NFET 127 turns on. According to the teachings herein, during a subinterval from time t3 to time t4, the current reversing path 125 may sink current. In turn the inductor 113 is reverse energized so that inductor current IL increases in the reverse (i.e., negative) direction.

At time t4 the gate signal V_{GZ} is exerted low and NFET 127 turns off. Also, according to the teachings herein, during the subinterval from time t4 to time t5, energy stored in the inductor 113 may allow the switch node voltage V_{SW} to increase before the high side switch 110 is turned on at time t5. Indeed, waveform 203, the switch node voltage V_{SW}, increases before the gate signal V_{GH} is exerted high. In this manner the voltage across the high side switch 110 (e.g., the drain-to-source voltage across high side switch 110) may be substantially reduced prior to turning on high side switch 110.

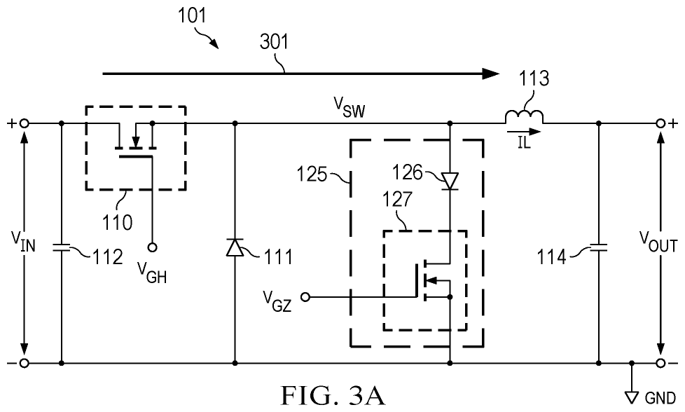

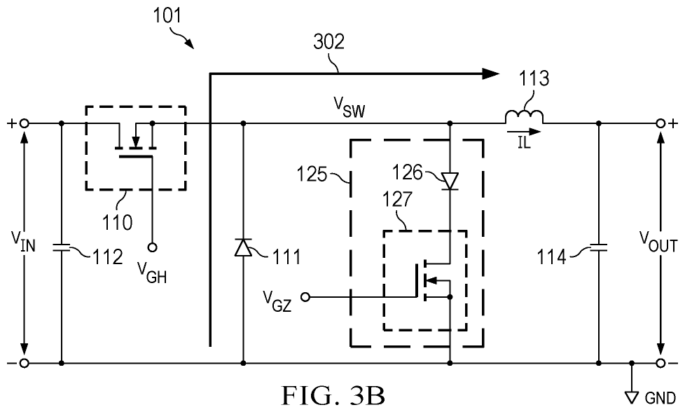

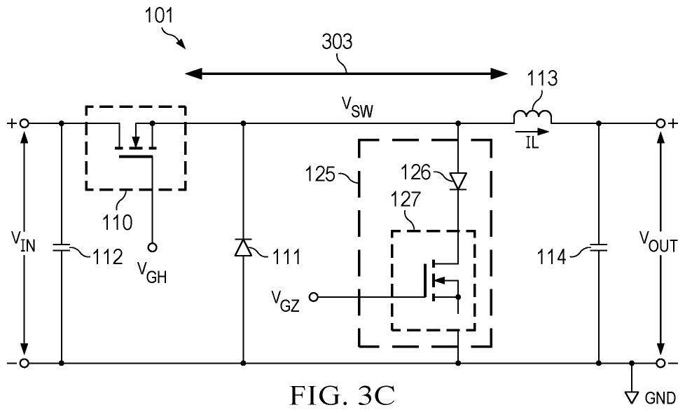

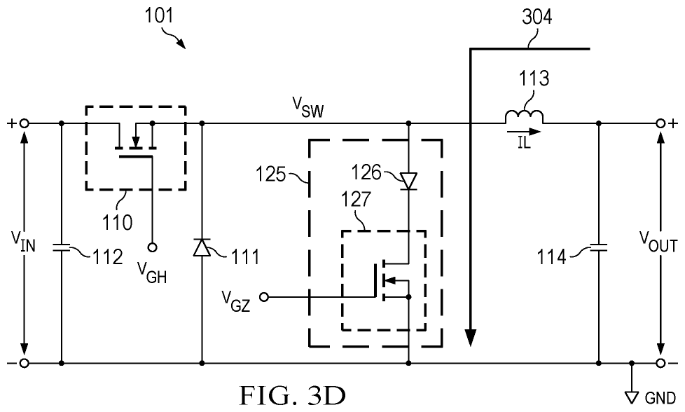

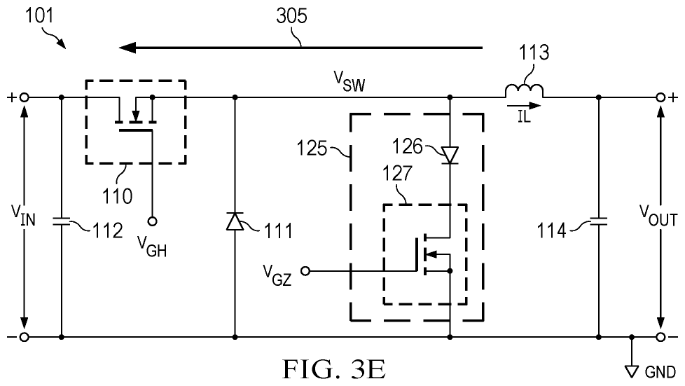

FIG. 3A illustrates an inductor current path 301 during a subinterval from time t0 to time t1 according to an embodiment. With reference to waveforms 201-204, during the subinterval from time t0 to time t1 the high side switch 110 is turned on. Therefore, the inductor current path 301 includes the high side switch 110; and the switch node voltage V_{SW} may be equal to the input voltage V_{IN} less any voltage drop across the high side switch 110. During the subinterval from time t0 to time t1, the inductor 113 is energized.

FIG. 3B illustrates an inductor current path 302 during a subinterval from time t1 to time t2 according to an embodiment. With reference to waveforms 201-204, during the subinterval from time t1 to time t2, the high side switch 110 is turned off; and the inductor current path 302 includes the forward biased freewheeling diode 111. During the subinterval from time t1 to time t2, inductor current IL decreases towards zero (0) while the inductor 113 is de-energized.

FIG. 3C illustrates an inductor current path 303 during a subinterval from time t2 to time t3 according to an embodiment. With reference to waveforms 201-204, the current path 303 may be an alternating current (ac) current path 303 related to the ringing of switch node voltage V_{SW} and inductor current IL. At time t2 the freewheeling diode 111 is reverse biased, and the high side switch 110 is off. The inductor current IL and the switch node voltage V_{SW} may oscillate (ring) as a function of parasitic capacitance present at the switch node in combination with an inductance of inductor 113.

FIG. 3D illustrates an inductor current path 304 during a subinterval from time t3 to time t4 according to an embodiment. At time t3 NFET 127 is turned on. With reference to waveforms 201-204, during the subinterval from time t3 to time t4, the current reversing path 125 may sink current (i.e., may sink a reverse current) along current path 304. During the subinterval from time t3 to time t4, the inductor 113 is reverse energized so that inductor current IL increases in the reverse (i.e., negative) direction.

FIG. 3E illustrates an inductor current path 305 during a subinterval from time t4 to time t5 according to an embodiment. At time t4 the gate signal V_{GZ} is exerted low and NFET 127 turns off. With reference to waveforms 201-204, during the subinterval from time t4 to time t5, energy stored in the inductor 113 allows inductor current IL to flow to the high side switch 110. The high side switch 110 is turned off; however, the inductor current IL may charge parasitic capacitance at the switch node so that the switch node voltage V_{SW} increases. Alternatively, and additionally, inductor current IL may forward bias body diode 131 allowing switch node voltage V_{SW} to rise slightly above the input voltage V_{IN}.

Thus, according to the teachings herein, the switch node voltage V_{SW} may increase before the high side switch 110 is turned on at time t5 to avail zero voltage switching (ZVS).

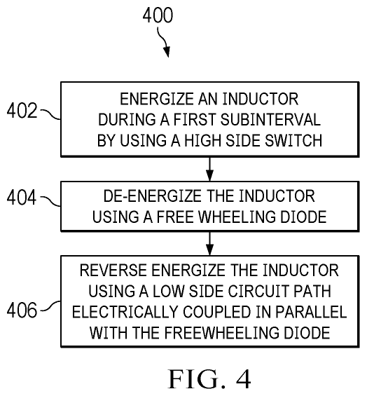

FIG. 4 illustrates a conceptual flow diagram 400 of zero voltage switching during a switching cycle according to an embodiment. Step 402 may correspond with energizing an inductor 113 during the subinterval from time t0 to time t1 of FIG. 2. The subinterval from time t0 to time t1 may also be referred to as a first subinterval. Alternatively, and additionally, the subinterval from time t0 to time t1 may also be referred to as an energizing subinterval.

Step 404 may correspond with de-energizing the inductor 113 during the subinterval from time t1 to time t2; and the subinterval from time t1 to time t2 may be referred to as a second subinterval. Alternatively, and additionally, the subinterval from time t1 to time t2 may also be referred to as a de-energizing subinterval.

Step 406 may correspond with reverse energizing the inductor 113 using a low side circuit path (i.e., the current reversing path 125) during the subinterval from time t3 to time t4. The low side current path (i.e., current reversing path 125) is electrically coupled in parallel with the freewheeling diode 111. The subinterval from time t3 to time t4 may be referred to as a third subinterval. Alternatively, and additionally, the subinterval from time t3 to time t4 may also be referred to as a reverse energizing subinterval.

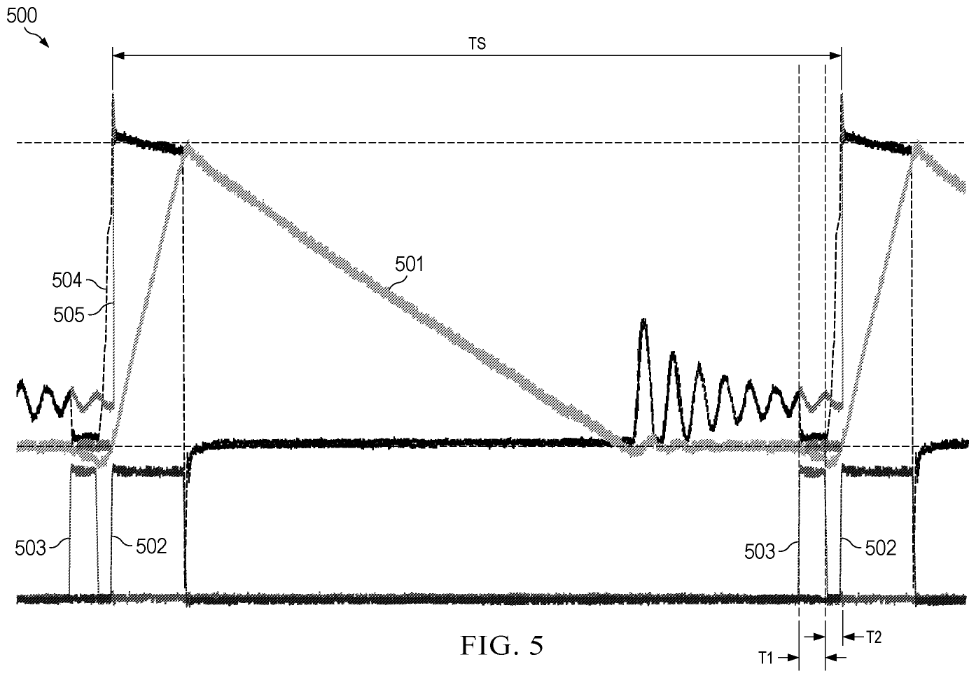

FIG. 5 compares waveforms 501-505 during a switching cycle TS according to an embodiment. Waveforms 501-503 may correspond with inductor current IL, gate signal V_{GH}, and gate signal V_{GZ}, respectively. As illustrated, gate signal V_{GZ} (waveform 503) may transition high during subinterval T1 and transition low for during subinterval T2 prior to the transition of gate signal V_{GH} (waveform 502).

As one of ordinary skill in the art may appreciate, the waveforms 501-505 are plotted as a function of time, and the timing scale may depend, at least in part, upon component values (e.g., an inductance of inductor 113) and/or upon configuration (e.g., input voltage V_{IN}). For instance, as illustrated in FIG. 5, the switching cycle TS may be approximately ten microseconds (10 us); and the peak value of the inductor current IL may exceed one amp (e.g., 1.2 amps). Also, subinterval T1 may be approximately one half of a microsecond (0.5 us), and subinterval T2 may be approximately one fourth of a microsecond (0.25 us).

Waveform 504 may correspond with the switch node voltage V_{SW}, when the gate signal V_{GZ} (waveform 503) transitions high during subinterval T1 while waveform 505 may correspond with the switch node voltage V_{SW} when the gate signal V_{GZ} is disabled (i.e., remains low) during switching cycle TS (i.e., during subinterval T1). Comparison of waveforms 504 and 505 shows that by using gate signal V_{GZ} to allow the current reversing path 125 to sink current during subinterval T1, the switch node voltage V_{SW} (waveform 504) may advantageously undergo zero voltage switching.

### CONCLUSION

The above description of illustrated examples of the present disclosure, including what is described in the Abstract, are not intended to be exhaustive or to be limited to the precise forms disclosed. While specific embodiments of, and examples for zero voltage switching in a BUCK converter are described herein for illustrative purposes, various equivalent modifications are possible without departing from the broader spirit and scope of the present disclosure. Indeed, it is appreciated that the specific example voltages, currents, frequencies, power range values, times, etc., are provided for explanation purposes and that other values may also be employed in other embodiments and examples in accordance with the teachings herein.

The foregoing description may refer to elements or features as being “connected,” “electrically connected,” and/or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

Moreover, conditional language used herein, such as, among others, “can,” “could,” “might,” “may,” “e.g.,” “for example,” “such as” and the like, unless specifically stated otherwise or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while the disclosed embodiments are presented in a given arrangement, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. Accordingly, the scope of the present invention is defined only by reference to the appended claims.

Although the claims presented here are in single dependency format for filing at the USPTO, it is to be understood that any claim may depend on any preceding claim of the same type except when that is clearly not technically feasible.

The present invention is defined in the claims; however, it should be understood that the present invention can alternatively be defined in accordance with the following examples.

Example 1: A BUCK converter comprises a high side switch, a freewheeling diode, and a current reversing path. The high side switch is electrically coupled to an inductor and configured to energize the inductor during a first subinterval of a switching cycle. The freewheeling diode is electrically coupled to de-energize the inductor during a second subinterval of the switching cycle. The current reversing path is electrically coupled in parallel with the freewheeling diode and configured to reverse energize the inductor during a third subinterval of the switching cycle.

Example 2: The BUCK converter of example 1, wherein the BUCK converter is a high voltage BUCK converter.

Example 3: The BUCK converter of any one of the preceding examples, wherein the high side switch comprises a field effect transistor (FET).

Example 4: The BUCK converter of any one of the preceding examples, wherein the FET is an N-channel FET (NFET).

Example 5: The BUCK converter of any one of the preceding examples, wherein the FET comprises a body diode.

Example 6: The BUCK converter of any one of the preceding examples, wherein the freewheeling diode is further coupled to de-energize the inductor such that the BUCK converter operates in a discontinuous conduction mode during the switching cycle.

Example 7: The BUCK converter of any one of the preceding examples, wherein the freewheeling diode is further coupled to de-energize the inductor such that the BUCK converter operates in a boundary conduction mode during the switching cycle.

Example 8: The BUCK converter of any one of the preceding examples, wherein the current reversing path is configured to sink a reverse current during the switching cycle.

Example 9: The BUCK converter of any one of the preceding examples, wherein the current reversing path is configured to operate as a single quadrant switch.

Example 10: The BUCK converter of any one of the preceding examples, wherein the current reversing path comprises a bipolar junction transistor (BJT).

Example 11: The BUCK converter of any one of the preceding examples, wherein the current reversing path comprises a gallium nitride (GaN) cascode switch.

Example 12: The BUCK converter of any one of the preceding examples, wherein the current reversing path comprises a field effect transistor (FET).

Example 13: The BUCK converter of any one of the preceding examples, wherein the FET is a GaN FET.

Example 14: The BUCK converter of any one of the preceding examples, wherein the FET is an N-channel FET (NFET).

Example 15: The BUCK converter of any one of the preceding examples, wherein the NFET comprises a body diode.

Example 16: The BUCK converter of any one of the preceding examples, wherein the current reversing path further comprises a diode electrically coupled in series with the FET.

Example 17: A method of controlling a BUCK converter during a switching cycle comprises: energizing an inductor during a first subinterval by using a high side switch; de-energizing the inductor during a second subinterval by using a freewheeling diode; and reverse energizing the inductor during a third subinterval by using a low side circuit path electrically coupled in parallel with the freewheeling diode.

Example 18: The method of example 17, wherein the switching cycle is a steady state switching cycle.

Example 19: The method of any one of the preceding examples, wherein de-energizing the inductor during the second subinterval by using the freewheeling diode comprises: operating the BUCK converter in discontinuous conduction mode.

Example 20: The method of any one of the preceding examples, wherein de-energizing the inductor during the second subinterval by using the freewheeling diode comprises: operating the BUCK converter in boundary conduction mode.

Example 21: The method of any one of the preceding examples, wherein the second subinterval is subsequent to the first subinterval.

Example 22: The method of any one of the preceding examples, wherein the third subinterval is subsequent to the second subinterval.

What is claimed is:

1. A BUCK converter comprising:
a high side switch electrically coupled to an inductor and configured to energize the inductor during a first subinterval of a switching cycle;
a freewheeling diode electrically coupled to de-energize the inductor during a second subinterval of the switching cycle; and
a current reversing path electrically coupled in parallel with the freewheeling diode and configured to reverse energize the inductor during a third subinterval of the switching cycle.

2. The BUCK converter of claim 1, wherein the BUCK converter is a high voltage BUCK converter.

3. The BUCK converter of claim 1, wherein the high side switch comprises a field effect transistor (FET).

4. The BUCK converter of claim 3, wherein the FET is an N-channel FET (NFET).

5. The BUCK converter of claim 4, wherein the FET comprises a body diode.

6. The BUCK converter of claim 1, wherein the freewheeling diode is further coupled to de-energize the inductor such that the BUCK converter operates in a discontinuous conduction mode during the switching cycle.

7. The BUCK converter of claim 1, wherein the freewheeling diode is further coupled to de-energize the inductor such that the BUCK converter operates in a boundary conduction mode during the switching cycle.

8. The BUCK converter of claim 1, wherein the current reversing path is configured to sink a reverse current during the switching cycle.

9. The BUCK converter of claim 1, wherein the current reversing path is configured to operate as a single quadrant switch.

10. The BUCK converter of claim 1, wherein the current reversing path comprises a bipolar junction transistor (BJT).

11. The BUCK converter of claim 1, wherein the current reversing path comprises a gallium nitride (GaN) cascode switch.

12. The BUCK converter of claim 1, wherein the current reversing path comprises a field effect transistor (FET).

13. The BUCK converter of claim 12, wherein the FET is a GaN FET.

14. The BUCK converter of claim 12, wherein the FET is an N-channel FET (NFET).

15. The BUCK converter of claim 14, wherein the NFET comprises a body diode.

16. The BUCK converter of claim 12, wherein the current reversing path further comprises a diode electrically coupled in series with the FET.

17. A method of controlling a BUCK converter during a switching cycle, the method comprising:
energizing an inductor during a first subinterval by using a high side switch;
de-energizing the inductor during a second subinterval by using a freewheeling diode; and
reverse energizing the inductor during a third subinterval by using a low side circuit path electrically coupled in parallel with the freewheeling diode.

18. The method of claim 17, wherein the switching cycle is a steady state switching cycle.

19. The method of claim 17, wherein de-energizing the inductor during the second subinterval by using the freewheeling diode comprises:
operating the BUCK converter in discontinuous conduction mode.

20. The method of claim 17, wherein de-energizing the inductor during the second subinterval by using the freewheeling diode comprises:
operating the BUCK converter in boundary conduction mode.

21. The method of claim 17, wherein the second subinterval is subsequent to the first subinterval.

22. The method of claim 17, wherein the third subinterval is subsequent to the second subinterval.
